(19) United States
(12) Patent Application Publication
(10) Pub. No.: US 2025/0256273 A1
(43) Pub. Date: Aug. 14, 2025

(54) TRANSFER SYSTEM FOR USE IN A PHARMACEUTICAL BARRIER SYSTEM, IN PARTICULAR AN ISOLATOR, BETA COMPONENT FOR USE IN A TRANSFER SYSTEM, BARRIER SYSTEM, IN PARTICULAR AN ISOLATOR, AND PRODUCTION FACILITY

(71) Applicant: Syntegon Technology GmbH, Waiblingen (DE)

(72) Inventors: Melanie Harenberg, Schwäbisch Hall (DE); Christopher Klemm, Aurach (DE); Matthias Schwandt, Wallhausen (DE); Markus Heinz, Gundelsheim (DE); Albrecht Kühnle, Crailsheim (DE); Bernd Sigwart, Crailsheim (DE); Michael Dietrich, Neuenstein (DE); Matthias Rottler, Langfurth (DE)

(21) Appl. No.: 19/040,019

(22) Filed: Jan. 29, 2025

(30) Foreign Application Priority Data
Feb. 8, 2024 (DE) 10 2024 103 510.2

(51) Int. Cl. B01L 1/02; B65G 1/06

(52) U.S. Cl. CPC B01L 1/02; B65G 1/06; B01L 2200/08; B01L 2200/141; B01L 2200/18; B01L 2300/041; B65G 2207/26

(57) ABSTRACT

The invention relates to a transfer system (1) for use in a barrier system (2) and to a beta component (8) for use in a transfer system (1) and to a barrier system (2) and to a production facility (3).

### BACKGROUND

In production facilities used in the pharmaceutical industry, it is often important during a production process to ensure sterile handling of the products in question. Particularly high requirements are placed on the separation of highly potent pharmaceuticals from the environment.

For this purpose, corresponding production facilities typically have a barrier system. A barrier system in this sense can be a so-called isolator having an isolation region that is hermetically separated from and sealed with respect to the environment. However, the term barrier system also includes RAB (Restricted Access Barrier) systems in this case. The separated region of a RAB system will hereinafter also be referred to as an isolation region.

A RAB system represents a physical barrier between a production region and its operator environment. The production region is protected by special machine protection means consisting of a machine housing, securely locked doors and, for example, glove ports. Depending on the type of ventilation, RAB systems can be divided into active and passive systems. Active RAB systems are equipped with special ventilation facilities, while passive RAB systems are connected to the existing clean room ceiling of the surrounding grade B room. They represent an attractive option for existing clean rooms for improving production quality and for applications that require greater flexibility. When properly operated as an integrated system, RAB technology can achieve the microbiological quality of an isolator.

However, an isolator is a completely closed system where the operator and the process region or isolation region are completely separated. Pharmaceutical isolators are typically equipped with a fully reproducible and validatable bio-decontamination system (usually H202) and associated process ventilation technology that can ensure temperature control by heating or cooling as well as permanent overpressure control of the process region relative to the operator environment to avoid the ingress of contaminated air. If the escape of, for example, active ingredients is to be prevented, the isolator is typically operated under negative pressure.

The isolation region or forms a closed environment with its own atmosphere, which meets special requirements regarding purity and freedom from contamination and also prevents, for example, highly potent pharmaceutical active ingredients from escaping into the environment. In other words, the barrier system or isolator or the RAB system forms a region that is separated from the environment and in which sterile and closed handling of the products is possible. “Closed” in this sense means in particular hermetic separation, which on the one hand prevents the entry of contamination and, on the other hand, stops substances or products (e.g. active pharmaceutical ingredients) in the isolator from escaping.

The isolation region is separated from an operating region located outside the barrier system, in which region operating personnel can be present, at least by a partition. The separating element is typically part of the housing that surrounds the isolation region. From the operating region, personnel can manipulate products and objects in the barrier system (isolator or RAB system) using, for example, remote-controlled handling devices and/or glove ports.

So-called transfer systems (also known as rapid transfer ports) are known for enabling objects to be moved from the operating region to the isolation region (or vice versa) while ensuring that the isolation region is separated from the environment. Such a transfer system has an alpha component and a beta component that functionally interacts therewith. The alpha component comprises an alpha port integrated into the partition, which is connected to or integrated into the partition by means of an alpha flange. Furthermore, the alpha component includes an openable and closable alpha closure unit for opening and closing the alpha port. The alpha closure unit is pivotally mounted on the alpha flange.

The beta component in turn comprises a beta flange and a removable beta closure unit for coupling to the alpha component. When the alpha component and the beta component are used or coupled as intended, they form a type of lock, by means of which the objects can be introduced into the isolation region while ensuring this region remains sterile. When coupled, the beta closure unit is connected to the alpha closure unit and can move together therewith. The beta closure unit therefore pivots with the alpha closure unit when the latter opens.

A beta container is also arranged on the beta flange and is closed by the beta closure unit. The beta container is in particular dimensionally stable. Objects that are to be introduced into the isolation region or removed from the barrier system when unloading it can be placed in the beta container. The beta container accordingly comprises a receiving space in its interior for storing the objects.

The beta flange and alpha flange have fixed predefined sizes. Various standardized sizes are known.

With known transfer systems, the problem regularly arises that their receiving capacity is limited and only individual objects or objects for only one step of the process of setting up a barrier system can fit in the beta container. After introducing an object, a new beta component must be docked with the other objects required in the barrier system and opened. Each of the beta components are sterilized or autoclaved. Nevertheless, it is not desirable to frequently change the docked beta component since, in addition to the associated effort, there is also an increased risk of contamination.

To ensure process safety and efficiency, there is therefore a need for a way to quickly and safely introduce the required objects into the barrier system.

### SUMMARY

The object of the present invention is to provide an improved solution with regard to the problems discussed above, which enables an efficient and process-reliable way of introducing objects into a barrier system.

The object is achieved by a transfer system for a barrier system with a sterile isolation region as well as a beta component for such a transfer system.

The barrier system is separated from a non-sterile operating region by a partition. The transfer system is designed to transfer objects from the operating region to the isolation region and vice versa. The transfer system comprises an alpha component and a beta component. The alpha component comprises an alpha flange for connection to the partition and an openable and closable alpha closure unit. The beta component has a beta flange and a removable beta closure unit for coupling to the alpha component.

The beta component further comprises a beta container, in particular a dimensionally stable beta container, with a receiving space.

It can now be provided within the scope of the invention that a magazine device is arranged in the receiving space of the beta component. The magazine device can hold a plurality of objects to be transferred from the receiving region, through the beta flange and to the isolation region.

A plurality of receptacles in the beta component, in particular in a magazine device, offers the advantage of saving changeover times, since docking and undocking of individual canisters or beta components is dispensed with. Furthermore, the risk of pharmaceutical contamination during docking and undocking is increased due to the numerous changeovers, which is also improved within the scope of the invention, or the risk is reduced by avoiding numerous changeovers.

The magazine device can comprise at least two receptacles for objects, wherein the objects are intended to be transferred from the receiving space, through the beta flange and to the isolation region.

The magazine device in the receiving space or in the beta container can be designed in such a way that one of the receptacles can be positioned in a removal position so that in the removal position the objects received in the respective receptacles are positioned so as to be removed through the beta flange (and the alpha flange when connected) and transferred to the isolation region. In the removal position, the objects held in the receptacle are positioned in such a way that they can be removed through the beta flange and the alpha flange (when coupled). They can be removed from inside the barrier system, for example via glove ports or by means of a robot arranged in the barrier system.

The beta component may comprise a connection for a sterilization medium. By means of the connection, a sterilization medium can be supplied to the receiving space in order to sterilize it and any objects located therein. The beta component may further comprise a drain for removing sterilization medium from the receiving space.

The beta component can be designed as a kind of SIP-capable (steam-in-place) canister that can be internally autoclaved. For example, sterile steam and compressed air are connected on one side and condensate or waste water is discharged on the other side, in particular via the drain mentioned above.

Once sterile steam and compressed air have been applied to the beta component, an autoclaving process (e.g. 121° C. for minimum 25 minutes; the use of other process parameters, i.e. temperatures and dwell times, is also possible here) is carried out within the beta component. The beta component is designed as a pressure-tight object.

The possibility of sterilizing the beta component together with the objects it contains is particularly advantageous in combination with the magazine device. In this way, a plurality of objects can be sterilized at the same time as the beta component or its receiving space. Furthermore, the receptacles or the objects they contain can be moved during sterilization, which can help avoid cold spots and improve the sterilization process, for example.

The beta component may comprise a collecting basin for sterilization medium or its condensate. A bottom of the collecting basin can have a gradient toward a drain, wherein the collecting basin in particular forms a bottom surface of the receiving space. This ensures efficient and complete removal of the sterilization medium or its condensate. The drain is located in particular at the deepest point of the collecting basin. The deepest point of the collecting basin forms in particular the deepest point of the receiving space. In particular, the receiving space is designed to be free of local depressions that are not connected to the drain via a gradient. This encourages the complete drainage of the sterilization medium or its condensate.

The magazine device can be designed to move the receptacles of the magazine device on a simple closed curve in order to move them into or out of the removal position. This allows for easy movement or guidance of the receptacles to move them in and out of the removal position. The curve can be a circle, an ellipse or an egg-shaped curve. It is also possible within the meaning of the invention that the curve has a rectangular shape which may have rounded corners.

The magazine device can be designed to rotate the receptacles of the magazine device about an axis of rotation in order to move them into or out of the removal position. The axis of rotation can extend horizontally or vertically. A simple rotational movement is structurally easy to implement and ensures that all the receptacles are moved into the removal position in the same way.

The magazine device can be designed to provide full receptacles, i.e. receptacles comprising objects to be transferred, on a first side of the beta flange at a first distance and, after they have been positioned in the removal position on the beta flange, to move the receptacles to a second side of the beta flange which is opposite the first side. The magazine device effectively guides the receptacles past the beta flange. The receptacles can be mounted on the second side at a second distance that is smaller than the first distance. After the objects have been removed, the receptacles can effectively be mounted so as to be stored closer together. The motion path of the receptacles can generally, and especially in this example, run in a straight line. Corresponding guidance of the receptacles is structurally easy to implement.

The beta flange of the beta component may be arranged on a coupling side of the beta component and the beta component may have a closable loading opening on a loading side of the beta component. The coupling side can in particular be arranged opposite the loading side. However, the coupling side and the loading side can also be offset by 90° from one another. An offset arrangement of the coupling side and loading side allows the openable area to be maximized and facilitates loading.

Each receptacle may be provided with a pull-out drawer-like, in particular replaceable, insert for receiving the objects to be transferred. The transfer system can be designed in such a way that, when the alpha component and the beta component are connected to one another and opened, the insertion of the receptacle, which is currently positioned in the removal position, can be moved from the receiving space, through the alpha flange and into the isolation region. The use of the inserts enables precise and reproducible positioning of the objects. Replaceable inserts can be removed with the objects in the barrier system. This is particularly beneficial for mounting the receptacles closer together after the inserts and objects have been removed.

The objects can be placed in the inserts outside the beta component. The inserts are then inserted into the beta component. The beta component can then be closed and the beta component can subsequently be supplied with sterilization medium in order to sterilize its interior and the objects and inserts placed therein.

The beta component can be mobile. The beta component can comprise rollers with which it can be moved. The position of the beta flange can be vertically adjusted relative to the rollers by means of a vertical adjustment device. This allows the beta component to be moved flexibly and be connected, for example, to a sterilization medium and then brought to its location of use. A vertical adjustment enables, for example, connection to alpha ports in different positions. A mobile beta component with a magazine device can be easily moved from the loading location to the location of use on the barrier system. If the beta component also comprises a connection for a sterilization medium, it can also be easily moved to a sterilization medium supply point and from there to the barrier system. All objects can be loaded, sterilized and then introduced into the barrier system in one movement sequence.

The magazine device can be designed as a paternoster system so that the receptacles are arranged the whole way around the paternoster system. This allows the receptacles to be moved efficiently and arranged in a space-saving manner. In particular, flexible geometries of objects and/or inserts can be accommodated in the holders.

According to the invention, it can be provided that the transfer system has at least one centering device assigned to an insert, which centering device can be arranged in the isolation region or is arranged in the isolation region when the transfer system is used as intended. According to the invention, the centering device and the insert each have at least one engagement element, wherein the engagement elements on the centering device and the insert are designed to be complementary to one another in such a way that they can be brought into engagement with one another in order to center the insert in a centered position so that the insert is fixed in a force-fitting or form-fitting manner in a vertical direction at least on one side, in particular on both sides (at the top and bottom). In particular, the engagement elements on the centering device and the insert are designed to be complementary to one another in such a way that they can be brought into engagement with one another in order to center the insert in the centered position in such a way that the insert is also pre-positioned, in particular fixed, in its position in a force-or form-fitting manner in a horizontal plane.

In relation to the present invention, “fixed on one side in the vertical direction” means that the insert rests on the centering device at least in regions and is thus supported at the bottom. “Fixed” means that the insert is not thrust into the centering position, i.e. it does not remain in the centering position under tension, but is guided into the centering position without tension and then locked therein. “Pre-positioned” in this sense means fixed in a position with a certain amount of play so that only slight movements around the fixed position in the horizontal plane are possible.

Fixing the insert in a force-fitting manner can be achieved, for example, by a rubberized gripping jaw, which enables the insert to be fixed without slipping.

According to the invention, a barrier system (in particular an isolator) with a partition is also provided, by means of which a sterile isolation region can be or is separated from a non-sterile operating region, wherein the barrier system has a transfer system for transferring objects from the operating region to the isolation region and vice versa. The barrier system is characterized in that the transfer system is designed according to the invention, as described above, wherein the centering device is arranged in the isolation region.

The combination of the magazine device and the centering device in particular enables the reliable use of a robot for unloading objects from the receptacles or loading them into the receptacles. The various inserts can always be positioned safely and reproducibly, thus the position of the objects is reliably defined.

When the transfer system is used as intended, the centering device is arranged in the isolation region.

According to the invention, a production facility is also provided, which is characterized in that it comprises the barrier system according to the invention described above.

The different inserts or receptacles can be tailored to specific objects. For example, an insert or a receptacle can be provided for format parts that are autoclaved and inserted. Objects can also be sedimentation plates, contact tests, or other EM materials, such as contact swabs and culture media, wash-down caps and germ count heads or the like. Furthermore, an insert or a receptacle can be provided for troubleshooting tools, e.g. tools for the robot, tweezers or wrenches. Furthermore, an insert or a receptacle can be provided for grippers for the robot or other materials for sampling, disinfection, labeling.

The inserts and/or receptacles may be provided with identification features. These can, for example, be optical features (e.g. barcodes or QR codes). Identification features can also be stored on RFID chips or other contactlessly readable feature carriers.

The receptacles or inserts can be pivotally arranged in the magazine device. Particularly in a magazine device in which the receptacles are rotatably arranged, this can enable the receptacles to always store the objects horizontally.

According to the invention, in particular the magazine device can be moved automatically in the transfer system. However, the magazine device can also be movable or operable manually, for example via a handwheel or one or more levers or a different actuating device. In particular, rotary movements, for example of the magazine device or the receptacles in the magazine device, can be advantageously implemented using a handwheel. The movements of the receptacles can be performable automatically or manually. The inserts of the transfer system can be movable automatically or manually. For example, an insert can be extended and retracted using a lever or a handwheel. Automatic movements can be implemented, for example, using electric motors or can be hydraulically or pneumatically driven.

### BRIEF DESCRIPTION OF THE DRAWINGS

In the following, the invention will be explained in more detail on the basis of the drawings. The same elements are provided-only once if appropriate-with the same reference signs. In the drawings:

FIG. 1 is a first simplified view of an advantageous transfer system arranged as intended on a barrier system in the open state;

FIG. 2 shows part of the transfer system in the closed state looking at the alpha port;

FIG. 3 is a side view of part of the transfer system in the open state;

FIG. 4 is a side view of a variant of the beta component of the transfer system;

FIG. 5 is a side view of another variant of the beta component of the transfer system;

FIG. 6 is a plan view of another variant of the beta component of the transfer system;

FIG. 7 is a side view of another variant of the beta component of the transfer system;

FIG. 8 is a side view of another variant of the beta component of the transfer system;

FIG. 9 is a side view of another variant of the beta component of the transfer system; and

FIG. 10 is a side view of another variant of the beta component of the transfer system.

### DETAILED DESCRIPTION

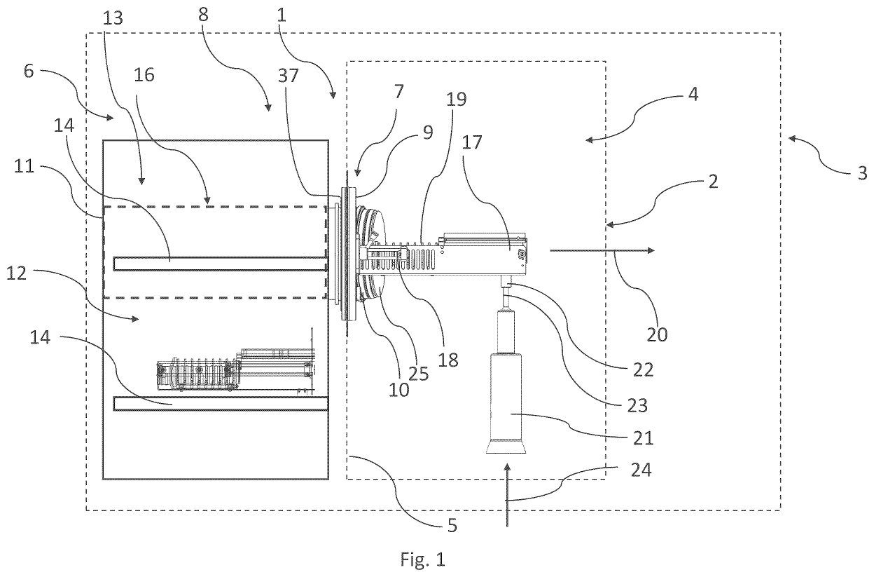

FIG. 1 is a simplified view of a transfer system 1. The transfer system 1 is intended or designed for arrangement or assembly on or in an isolator 2 (as an example of a barrier system; the following explanations of examples of an isolator are to be understood to also be valid for other barrier systems) which is only indicated by dashed lines in FIG. 1 here for reasons of clarity. The isolator 2 is part of a production facility 3, which is also only shown schematically by a dashed rectangle in the present case.

The isolator 2 is designed or constructed in such a way that it enables sterile handling of products, for example pharmaceutical or medical products. For this purpose, the isolator 2 forms a sterile isolation region 4 which is separated from a non-sterile operating region 6 at least by a partition 5. In this respect, the isolator 2 at least comprises the partition 5 in order to separate the sterile isolation region 4 from the non-sterile operating region 6.

The isolator 2 may also comprise additional components that are provided in known isolators of the type in question but not shown here for reasons of clarity.

The transfer system 1 serves or is designed to enable objects to be moved from the operating region 6 to the isolation region 4 while maintaining sterility in the isolation region 4. For this purpose, the transfer system 1 has an alpha component 7 intended for arrangement on the isolator 2 or the separating element 5 and a beta component 8 which can be coupled to the alpha component and in which the objects 15 to be transferred can be stored under sterile conditions.

The alpha component 7 comprises an alpha flange 9 which, as shown in FIG. 1, is intended for arrangement in the partition 5 or is integrated into the partition 5 when used as intended. Furthermore, the alpha component 7 has an alpha closure unit 10, which is pivotally mounted on the alpha flange 9 and can be moved into an open and a closed position. In the present case, the alpha closure unit 10 can only be opened if the beta component 8 is coupled to the alpha component 7 as intended. Otherwise, the alpha component 7 remains closed to maintain sterility.

The beta component 8 has a beta flange 37 and a removable beta closure unit 25, which serve for coupling it to the alpha component 7. The beta component 8 further comprises a beta container 11, which is dimensionally stable in the present case, with a receiving space 12. The beta container 11 is shown schematically in FIG. 1.

Within the context of the invention, a magazine device 13 is arranged in the receiving space 12 of the beta component 8 and comprises at least two receptacles 14 for objects 15. The objects 15 are intended to be transferred from the receiving space 12, through the alpha closure unit 10 and to the isolation region 4.

Within the context of the invention, the magazine device 13 is designed such that one of the receptacles 14 can be positioned in a removal position 16. In the removal position 16, the objects 15 received in the receptacle 14 are positioned such that they can be transferred to the isolation region 4 through the alpha flange 9 (or through the beta flange 37). For example, as illustrated in FIG. 1, a drawer-like insert 17 can be mounted in each receptacle 14 so as to be guided by means of guide means 18, which in the present case are designed as guide rails. The insert 17 serves or is designed to receive the objects 19 to be transferred. In order to transfer the objects, the insert 17 can be pulled out of the receiving space 12 by means of the guide means 18. The corresponding insert 17 can be moved out of the beta container 11 in a removal direction 20. The transfer system 1 can be configured (as shown in FIG. 1) such that a receptacle 14 located in the removal position 16 is arranged such that the corresponding insert 17 is aligned with the removal direction 20. The removal direction 20 extends through the alpha flange 9.

A centering device 21 can be arrangeable or arranged in the isolation region 4. The centering device 21 and the insert 17 can each have at least one engagement element 22, 23. The engagement elements 22, 23 on the centering device 21 and on the insert 17 can be designed to be complementary to one another. In particular, the engagement elements 22, 23 can be designed such that they can be brought into engagement with one another in order to center the insert 17 in a centering position such that the insert 17 is fixed in a vertical direction 24 in a force-fitting or form-fitting manner on at least one side, in particular on both sides, and the insert 17 is in particular also pre-positioned, in particular fixed, in its position in a force-fitting or form-fitting manner in a horizontal plane.

The engagement element 22, which is arranged on the side of the insert 17, can be designed, for example, as a centering sleeve or centering groove. The engagement element 23, which is arranged on the side of the centering device 21, can be designed, for example, as a centering bolt or centering pin and can have a complementary shape to the centering sleeve or centering groove. In this way, support in the vertical direction 24 and centering in the horizontal plane (orthogonal to the vertical direction 24) can be achieved. This can prevent the insert 17 from sagging. Objects 19 can be accurately positioned and automatically removed precisely and easily.

Corresponding engagement elements 22 can be provided on a plurality of, or each, insert 17 of the magazine device 13. This allows the inserts 17 to be uniformly positioned.

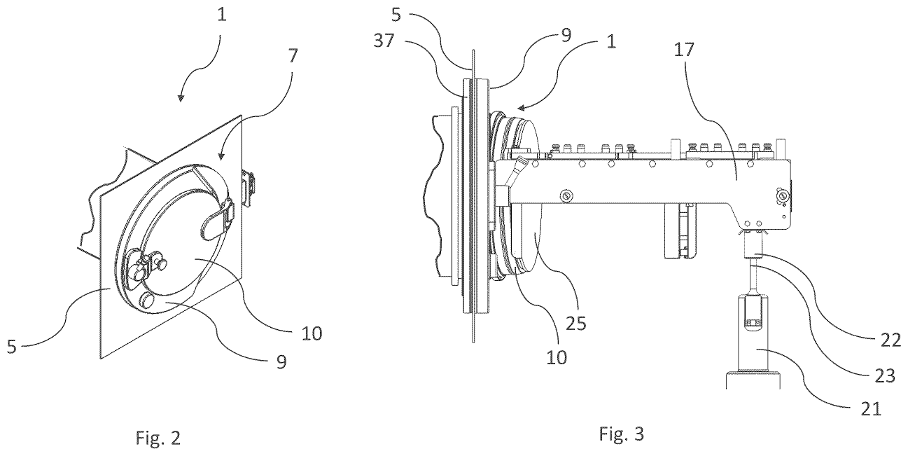

FIG. 2 shows the transfer system 1 seen from the isolation region 4 and in a closed state. The beta component 8 is only partially shown; in particular the beta container 11 is not completely shown, but only its connection to the beta flange 37.

FIG. 3 is a side view of the transfer system 1 in an open state with the insert 17 pulled out.

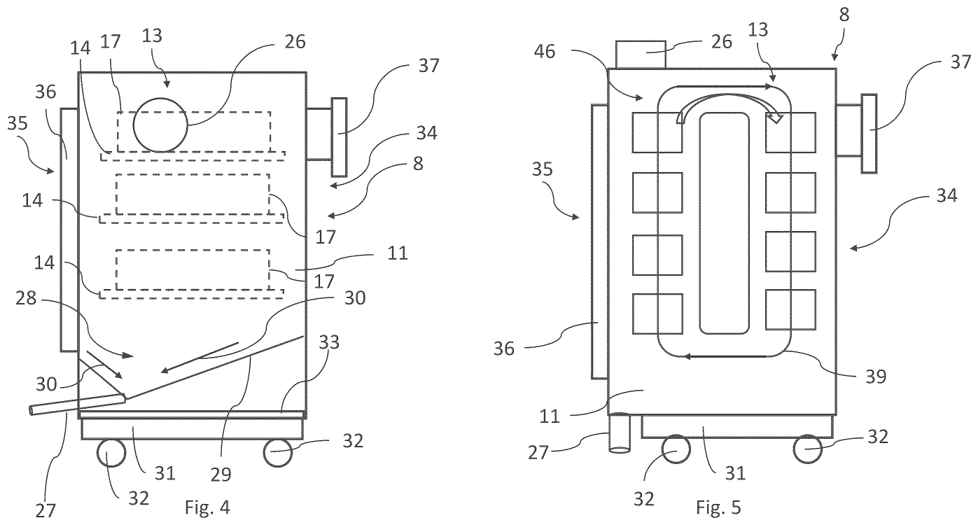

FIG. 4 is a side view of a beta component 8 of a transfer system 1. The beta component 8 comprises a connection 26 for a sterilization medium, by means of which the sterilization medium can be supplied to the receiving space 12. Steam (water vapor) is preferably used as the sterilization medium. H2O2 vapor can also be introduced into the beta component 8 as the sterilization medium. The sterilization medium can be supplied to the receiving space 12 in order to sterilize the receiving space and the objects 19 located therein. The beta component 8 can in particular comprise a drain 27 to remove sterilization medium from the receiving space 12.

The beta component 8 can comprise a collecting basin 28 for sterilization medium or its condensate. A bottom 29 of the collecting basin 28 preferably has a gradient 30 (indicated by arrows), the gradient 30 being directed toward the drain 27. The collecting basin 28 can in particular form a bottom surface of the receiving space 12.

The beta component 8 can comprise a substructure 31, which can be removable from the beta container 11, or can be designed, for example, to be integrally connected thereto. The substructure 31 can be used to transport the beta component 8. For this purpose, the substructure 31 can comprise rollers 32. Other designs are possible. For example, the substructure 31 can have recesses for attaching a lifting fork. In particular, the position of the beta flange 37 relative to the rollers 32 and/or the substructure 31 can be vertically adjusted by means of a vertical adjustment device 33.

The beta flange 37 of the beta component 8 is arranged on a coupling side 34 of the beta component 8. The beta component 8 can have a closable loading opening 36 on a loading side 35 of the beta component 8. The coupling side 34 can be arranged opposite the loading side 35, as shown, for example, in FIGS. 4 and 5. The coupling side 34 can be offset by 90° to the loading side 35.

FIG. 5 shows a variant of a beta component 8 in which the receptacles 14 are arranged the whole way around a paternoster system 46. The magazine device 13 is designed as a paternoster system 46 so that the receptacles 14 are arranged the whole way around the paternoster system 46 and can be guided past the beta flange 37.

The receptacles 14 of the magazine device 13 are moved on a simple closed curve 39 in order to move them into or out of the removal position 16.

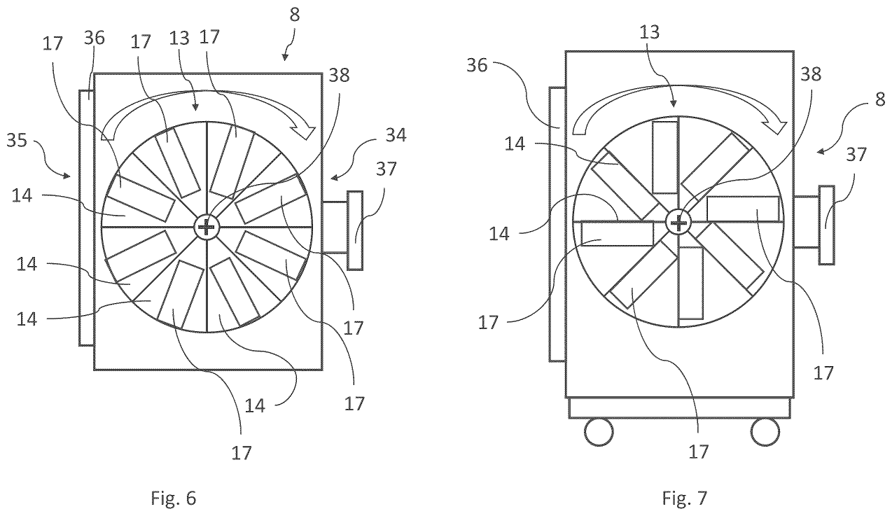

As illustrated in FIGS. 6 and 7, the magazine device 13 can be designed to rotate the receptacles 14 of the magazine device 13 about an axis of rotation 38. By means of the rotational movement, the receptacles 14 can be moved into or out of the removal position 16. In the beta component 8, which is shown from above in FIG. 6, the axis of rotation 38 extends vertically. In the beta component 8, which is shown from the side in FIG. 7, the axis of rotation 38 extends horizontally. In the present examples in FIGS. 6 and 7, the receptacles 14 move on a circular path in both cases.

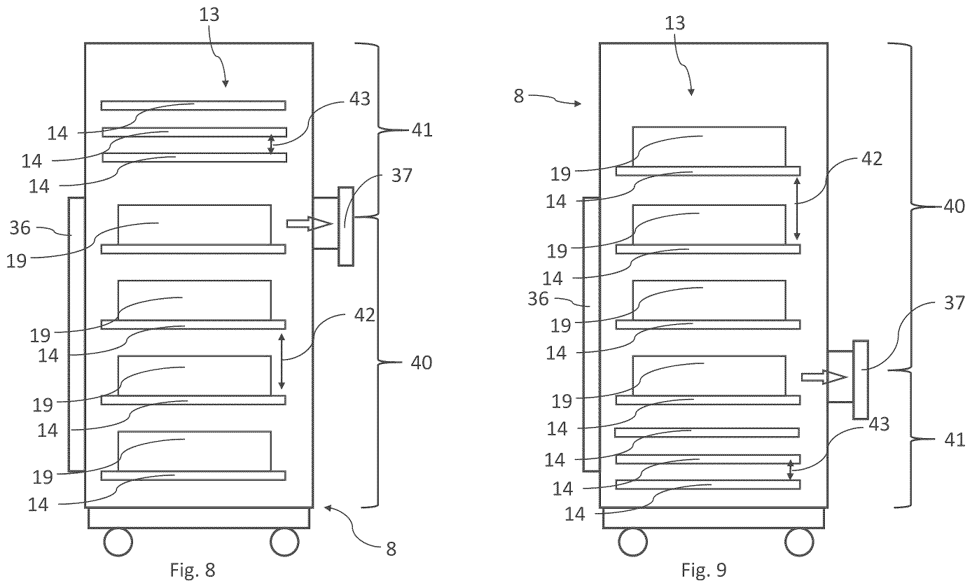

As illustrated in FIGS. 8 and 9, the magazine device 13 may be configured to provide full receptacles 14 on a first side 40 of the beta flange 37 at a first distance 42 and to move the receptacles 14, after they have been positioned in the removal position 16 on the beta flange 37, to a second side 41 of the beta flange 37 which is opposite the first side 40 (as viewed from the beta flange 37). The receptacles 14 are mounted on the second side 41 at a second distance 43 that is smaller than the first distance 42.

In FIG. 8, the first side 40 is below the beta flange 37. In FIG. 9, the first side 40 is above the beta flange 9.

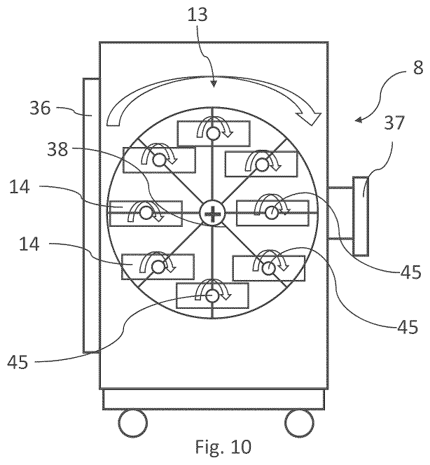

In the example in FIG. 10, the magazine device 13 is designed to rotate the receptacles 14 of the magazine device 13 about a horizontal axis of rotation 38. In the example in FIG. 10, the receptacles 14 move on a circular path. The receptacles are mounted, similarly to in the paternoster system in FIG. 5, in such a way that they maintain their orientation during rotation. They therefore always extend horizontally. For this purpose, they are each suspended in the magazine device 13 in a manner in which they are mounted so as to pivot about a secondary axis 45.

1. A transfer system (1) for a barrier system, the barrier system comprising a sterile isolation region (4) which is separated from a non-sterile operating region (6) by a partition (5), the transfer system (1) configured to transfer objects from the operating region (6) to the isolation region (4) and vice versa and the transfer system (1) comprising an alpha component (7) and a beta component (8), the alpha component (7) having an alpha flange (9) for connection to the partition (5) and an openable and closable alpha closure unit (10), the beta component (8) having a beta flange (37) and a removable beta closure unit for coupling to the alpha component (7), the beta component (8) further having a beta container (11) with a receiving space (12), wherein in the receiving space (12) of the beta component (8) there is arranged a magazine device (13) which comprises at least two receptacles (14) for objects (19), the objects (19) being intended to be transferred from the receiving space (12), through the beta flange (37) and to the isolation region (4), the magazine device (13) configured such that one of the receptacles (14) can be positioned in a removal position (16) each time so that, in the removal position (16), the objects (19) received in the receptacle (14) are positioned so as to be removed through the beta flange (37) and the alpha flange (9) and transferred to the isolation region (4).

2. A beta component (8) for use in a transfer system (1) for a barrier system, the barrier system comprising a sterile isolation region (4) which is separated from a non-sterile operating region (6) by a partition (5), the transfer system (1) being configured to transfer objects from the operating region (6) to the isolation region (4) and vice versa and the transfer system (1) comprising an alpha component (7) and a beta component (8), the alpha component (7) having an alpha flange (9) which is connected to the partition (5) and has an openable and closable alpha closure unit (10), the beta component (8) having a beta flange (37) and a removable beta closure unit for coupling to the alpha component (7), the beta component (8) further having a beta container (11) with a receiving space (12), wherein in the receiving space (12) of the beta component (8) there is arranged a magazine device (13) which comprises at least two receptacles (14) for objects (19), the objects (19) being intended to be transferred from the receiving space (12), through the beta flange (37) and to the isolation region (4), the magazine device (13) configured such that one of the receptacles (14) can be positioned in a removal position (16) so that, in the removal position (16), the objects (19) received in the receptacle (14) are arranged for removal through the beta flange (37).

3. The transfer system (1) according to claim 1, wherein the beta component (8) comprises a connection (26) for a sterilization medium, by which a sterilization medium can be supplied to the receiving space (12) in order to sterilize said receiving space and any objects (19) located therein.

4. The transfer system (1) according to claim 1, wherein the beta component (8) comprises a collecting basin (28) for sterilization medium or its condensate and a bottom (29) of the collecting basin (28) has a gradient (30) toward a drain (27).

5. The transfer system (1) according to claim 1, wherein the magazine device (13) is designed to move the receptacles (14) of the magazine device (13) on a simple closed curve (39) in order to move them into or out of the removal position (16).

6. The transfer system (1) according to claim 1, wherein the magazine device (13) is configured to rotate the receptacles (14) of the magazine device (13) about an axis of rotation (38) in order to move them into or out of the removal position (16).

7. The transfer system (1) according to claim 1, wherein the magazine device (13) is configured to provide full receptacles (14) on a first side (40) of the beta flange (37) at a first distance (42) and to move the receptacles (14) after they have been positioned in the removal position (16) on the beta flange (37) to a second side (41) of the beta flange (37) which is opposite the first side (40), wherein the receptacles (14) are mounted on the second side (41) at a second distance (43) that is smaller than the first distance (42).

8. The transfer system (1) according to claim 1, wherein the beta flange (37) of the beta component (8) is arranged on a coupling side (34) of the beta component (8) and the beta component (8) has a closable loading opening (36) on a loading side (35) of the beta component (8).

9. The transfer system (1) according to claim 1, wherein a pull-out drawer-like insert (17) is provided in each receptacle (14) for receiving the objects (19) to be transferred, wherein the transfer system (1) is configured such that when the alpha component (7) and the beta component (8) are connected to one another and are open, the insert (17) of the receptacle (14), which is currently positioned in the removal position, can be moved from the receiving space (12), through the alpha flange (10) and into the isolation region (4).

10. The transfer system (1) according to claim 1, wherein the beta component (8) comprises rollers (32) by which the beta component (8) can be moved, wherein a position of the beta flange (37) relative to the rollers (32) can be vertically adjusted by a vertical adjustment device (33).

11. The transfer system (1) according to claim 1, wherein the magazine device (13) is configured as a paternoster system (46) so that the receptacles (14) are arranged a whole way around the paternoster system (46).

12. A barrier system having a transfer system (1) according to claim 1, wherein a centering device (21) is arranged in the barrier system.

13. A production plant (3) comprising a barrier system according to claim 12.

14. The transfer system according to claim 1, wherein the barrier system includes an isolator (2).

15. The transfer system according to claim 1, wherein the beta container (11) is dimensionally stable.

16. The transfer system according to claim 9, wherein the pull-out drawer-like insert (17) is replaceable.

17. The transfer system according to claim 3, wherein the beta component (8) comprises a drain (27) for removing sterilization medium from the receiving space (12).

18. The transfer system according to claim 4, wherein the collecting basin (28) forms a bottom surface of the receiving space (12).

19. The transfer system according to claim 6, wherein the axis of rotation (38) extends horizontally or vertically.

20. The transfer system according to claim 8, wherein the coupling side (34) is opposite the loading side (35).
